(19) United States
(12) Patent Application Publication
(10) Pub. No.: US 2019/0115624 A1
(43) Pub. Date: Apr. 18, 2019

(54) ELECTROLYTE COMPRISING CYCLIC DINITRILES AND FLUOROETHERS

(71) Applicants: Mei Mei WU, Suzhou (CN); Jacky YANG, Suzhou (CN); Itamar Michael MALKOWSKY, Shanghai (CN); BASF Corporation, Florham Park, NJ (US)

(72) Inventors: Mei Mei WU, Suzhou (CN); Jacky YANG, Suzhou (CN); Itamar Michael MALKOWSKY, Shanghai (CN)

(73) Assignee: BASF Corporation, Florham Park, NJ (US)

(21) Appl. No.: 16/097,096

(22) PCT Filed: Apr. 28, 2016
(86) PCT No.: PCT/CN2016/080476

§ 371 Date: Oct. 26, 2018

(51) Int. Cl. H01M 10/0568; H01M 10/0567; H01M 10/0569; H01M 10/0525

(52) U.S. Cl. CPC H01M 10/0568; H01M 10/0567; H01M 10/0569; H01M 4/485; H01M 2300/0034; H01M 2300/0037; H01M 10/0525

(57) ABSTRACT

The invention is aimed at combining dinitrile heterocyclic additives with fluoroethers additives for electrolyte compositions, electrolyte compositions containing the additives and electrochemical devices containing the additives. The electrolyte compositions are suitable for use in electrochemical devices such as lithium ion batteries.

### FIELD OF TECHNOLOGY

This invention is aimed at additives for electrolyte compositions, electrolyte compositions containing the additives and electrochemical devices containing the additive. The electrolyte compositions are suitable for use in electrochemical devices such as lithium ion batteries.

### BACKGROUND

U.S. Pat. No. 7,008,728 describes electrolytes for lithium secondary batteries containing acrylonitrile or derivative thereof as additives forming an organic SEI on the negative electrode during initial charging. US2004/0013946 is aimed at electrolytic solutions for lithium batteries containing at least one nitrile compound like acetonitrile or 1,2-dicyanobenzene and at least one S═O group containing compound. WO2015/007554 teaches the use of malonitrile derivatives as additives for electrolytes in lithium ion batteries.

Further it is known to add halogen substituted ethers as co-solvents in the electrolytes of lithium secondary batteries. For example JP11026015, U.S. Pat. No. 5,795,677, US2012/0214073 and J. of Power Sources, 307, (2016), 772-781 teach the use of fluorinated ethers as electrolyte co-solvents.

Nevertheless there is still a need for enhancing the lifetime of secondary batteries and a demand for electrolyte additives leading to a prolonged life time and cycle stability of secondary lithium ion batteries.

### SUMMARY

The inventors have found that the cycle stability of secondary lithium ion batteries is surprisingly improved when combining a compound of formula (I) and a fluoroether of formula (II).

Thus the present application is directed to:

An electrolyte compositions (A) containing

(i) at least one aprotic organic solvent;
(ii) at least one conducting salt;
(iii) at least one compound of formula (I)

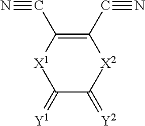

wherein
X¹, X², Y¹, and Y² are defined below, and
   (iv) and at least one fluoroether of formula (II)

R⁵—O—R⁶ (II)

wherein R⁵, R⁶ and X³ are defined below.

The use of the combination of compounds of formula (I) and formula (II) for electrolytes in electrochemical cells;

Electrochemical cells comprising the above described electrolyte composition (A), at least one cathode (B) comprising at least one cathode active material, and at least one anode (C) comprising at least one anode active material;

An electrochemical device selected from the group consisting of primary lithium batteries, rechargeable lithium ion batteries, double layer capacitors, lithium ion capacitors, solar cells, electrochromic displays, sensors and biosensor, which device contains an electrolyte composition of the electrolyte (A) defined above;

A rechargeable lithium ion battery comprising at least one anode, at least one cathode, a separator disposed between the electrodes and an electrolyte composition as defined by (A).

### DETAILED DESCRIPTION

### Terms

The articles “a” and “an” are used herein to refer to one or to more than one (i.e., to at least one) of the grammatical object of the article. For example, “an organic carbonate group” means one carbonate group or more than one carbonate group.

Any ranges cited herein are inclusive.

The terms “substantially” and “about” used throughout this specification are used to describe and account for small fluctuations. For example, they can refer to less than or equal to +5%, such as less than or equal to +2%, less than or equal to +1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

### The Electrolyte Composition (A)

The electrolyte composition (A) is preferably liquid at working conditions; more preferred it is liquid at 1 bar and 25° C., even more typically the electrolyte composition is liquid at 1 bar and −15° C., in particular the electrolyte composition is liquid at 1 bar and −30° C., even more preferred the electrolyte composition is liquid at 1 bar and −50° C.

The water content of the inventive electrolyte composition is preferably below 50 ppm, based on the weight of the electrolyte composition, more preferred below 20 ppm, most preferred below 10 ppm. The water content may be determined by titration according to Karl Fischer, e.g. described in detail in DIN 51777 or ISO760: 1978.

The content of HF of the inventive electrolyte composition is preferably below 50 ppm, based on the weight of the electrolyte composition, more preferred below 30 ppm, most preferred below 20 ppm. The HF content may be determined by titration according to potentiometric or potentiographic titration method.

The electrolyte of composition (A) contains

(i) at least one aprotic organic solvent;
(ii) at least one conducting salt;
(iii) at least one compound of formula (I)

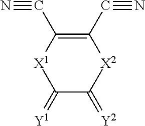

Wherein
X¹ and X² are independently from each other selected from N(R¹), P(R¹), O, and S;
R¹ is selected from H, C₁-C₁₀ alkyl, C₃-C₆ (hetero)cycloalkyl, C₂-C₁₀ alkenyl, C₃-C₆ (hetero)cycloalkenyl, C₂-C₆ alkynyl, C₅-C₇ (hetero)aryl, C₇-C₁₃ aralkyl, OR³, C(O)R³, C(NR³)R⁴, and C(O)OR³, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅—C(hetero)aryl, S(O)₂OR^{3a}, OS(O)₂R^{3a}, S(O)₂R^{3a}, OR^{3a}, C(O)R^{3a}, C(O)OR^{3a}, NR^{3a}R^{3b}, and NC(O)R^{3a}R^{3b};
   Y¹ and Y² are independently from each other selected from (O), (S), (PR²) and (NR²),
R² is selected from H, C₁-C₁₀ alkyl, C₃-C₆ (hetero)cycloalkyl, C₂-C₁₀ alkenyl, (hetero)C₃-C₆ cycloalkenyl, C₂-C₆ alkynyl, C₅-C₇ (hetero)aryl, C₇-C₁₃ aralkyl, OR^{2a} and C(O)R^{2a}, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{2b}, OS(O)₂R^{2b}, S(O)₂R^{2b}, OR^{2b}, C(O)R^{2b}, C(O)OR^{10b}, NR^{2b}R^{2c}, and NC(O)R^{2b}R^{2c}; and
R^{2a}, R^{2b} and R^{2c} are independently from each other selected from H, C₁-C₁₀ alkyl, C₃-C₆ (hetero)cycloalkyl, C₂-C₁₀ alkenyl, and C₅—C(hetero)aryl, wherein alkyl, (hetero)cycloalkyl, alkenyl, and (hetero)aryl may be substituted by one or more substituents selected from F and CN,
R³, R⁴, R^{3a}, and R^{3b} are selected independently from each other from H, C₁-C₁₀ alkyl, C₃-C₆ (hetero)cycloalkyl, C₂-C₁₀ alkenyl, C₃-C₆ (hetero)cycloalkenyl, C₂-C₆ alkynyl, C₅-C₇ (hetero)aryl, and C₇-C₁₃ aralkyl, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{3c}, OS(O)₂R^{3c}, S(O)₂R^{3c}, OR^{3c}, C(O)R^{3c}, C(O)OR^{3c}, NR³CR^{3d}, and NC(O)R^{3c}R^{3d};
R^{3c} and R^{3d} are selected independently from each other from H, C₁-C₁₀ alkyl, C₃-C₆ (hetero)cycloalkyl, C₂-C₁₀ alkenyl, and C₅-C₇ (hetero)aryl, wherein alkyl, (hetero)cycloalkyl, alkenyl, and (hetero)aryl may be substituted by one or more substituents selected from F and CN.
and
iv) at least one compound selected from the group consisting of Formula (II)

R⁵—O—R⁶ (II)
wherein R⁵ and R⁶ are independently a partially fluorinated C₁-C₁₀ alkyl group wherein the partially fluorinated C₁-C₁₀ alkyl group is a straight, saturated hydrocarbon chain having some of the hydrogen atoms in the alkyl group substituted by fluorine atoms.

### Aprotic Organic Solvent (i)

The electrolyte composition (A) contains at least one aprotic organic solvent (i), preferably at least two aprotic organic solvents (i). According to one embodiment the electrolyte composition (A) may contain up to ten aprotic organic solvents (i).

The at least one aprotic organic solvent (i) is preferably selected from

(a) cyclic and noncyclic organic carbonates, which may be partly halogenated,
(b) di-C₁-C₁₀-alkylethers, which may be partly halogenated,
(c) di-C₁-C₄-alkyl-C₂-C₆-alkylene ethers and polyethers, which may be partly halogenated,
(d) cyclic ethers, which may be partly halogenated,
(e) cyclic and acyclic acetales and ketales, which may be partly halogenated,
(f) orthocarboxylic acids esters, which may be partly halogenated,
(g) cyclic and noncyclic esters of carboxylic acids, which may be partly halogenated,
(h) cyclic and noncyclic sulfones, which may be partly halogenated,
(i) cyclic and noncyclic nitriles and dinitriles, which may be partly halogenated, and
(j) ionic liquids, which may be partly halogenated.

For example, the at least one aprotic organic solvent (i) is selected from cyclic and noncyclic organic carbonates (a), di-C₁-C₁₀-alkylethers (b), di-C₁-C₄-alkyl-C₂-C₆-alkylene ethers and polyethers (c) and cyclic and acyclic acetales and ketales (e), for example electrolyte composition (A) contains at least one aprotic organic solvent (i) selected from cyclic and noncyclic organic carbonates (a) and typically the electrolyte composition (A) contains at least two aprotic organic solvents (i) selected from cyclic and noncyclic organic carbonates (a), in particular electrolyte composition (A) contains at least one aprotic solvent (i) selected from cyclic organic carbonates and at least one aprotic organic solvent (i) selected from noncyclic organic carbonates.

The aprotic organic solvents (a) to (j) may be partly halogenated, e.g. they may be partly fluorinated, partly chlorinated or partly brominated, for example they may be partly fluorinated. “Partly halogenated” means, that one or more H of the respective molecule is substituted by a halogen atom, e.g. by F, Cl or Br. Preference is given to the substitution by F. The at least one solvent (i) may be selected from partly halogenated and non-halogenated aprotic organic solvents (a) to (j), i.e. the electrolyte composition may contain a mixture of partly halogenated and non-halogenated aprotic organic solvents.

Examples of suitable organic carbonates (a) are cyclic organic carbonates according to the general formula (a1), (a2) or (a3)

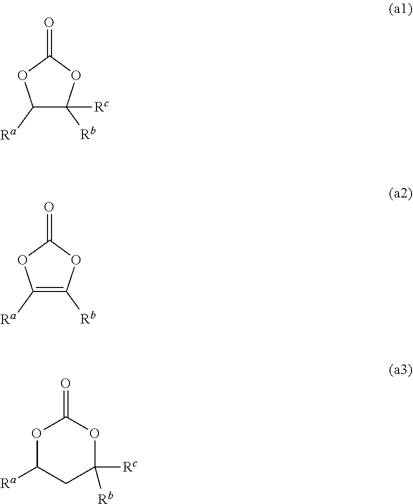

wherein
R^{a}, R^{b} and R^{c} being different or equal and being independently from each other selected from hydrogen; C₁-C₄-alkyl, preferably methyl; F; and C₁-C₄-alkyl substituted by one or more F, e.g. CF₃.

“C₁-C₄-alkyl” is intended to include methyl, ethyl, n-propyl, iso-propyl, n-butyl, iso-butyl, sec.-butyl and tert.-butyl.

Preferred cyclic organic carbonates (a) are of general formula (a1), (a2) or (a3) wherein R^{a}, R^{b} and R^{c} are H. Examples are ethylene carbonate, vinylene carbonate, and propylene carbonate. A preferred cyclic organic carbonate (a) is ethylene carbonate. Further preferred cyclic organic carbonates (a) are difluoroethylene carbonate (a4) and monofluoroethylene carbonate (a5)

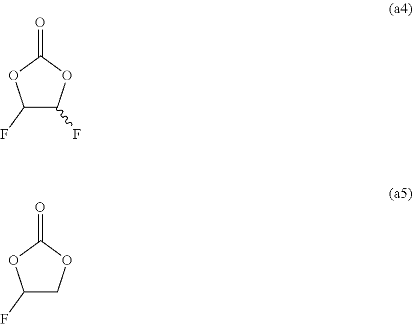 [SMILES: O=C1OC(F)C(F)O1 ; O=C1OCC(F)O1]

Examples of suitable non-cyclic organic carbonates (a) are dimethyl carbonate, diethyl carbonate, methylethyl carbonate and mixtures thereof.

In one embodiment of the invention the electrolyte composition (A) contains mixtures of non-cyclic organic carbonates (a) and cyclic organic carbonates (a) at a ratio by weight of from 1:10 to 10:1, preferred of from 3:1 to 1:3.

Examples of suitable non-cyclic di-C₁-C₁₀-alkylethers (b) are dimethylether, ethylmethylether, diethylether, diisopropylether, and di-n-butylether.

Examples of di-C₁-C₄-alkyl-C₂-C₆-alkylene ethers (c) are 1,2-dimethoxyethane, 1,2-diethoxyethane, diglyme (diethylene glycol dimethyl ether), triglyme (triethylenglycol dimethyl ether), tetraglyme (tetraethylenglycol dimethyl ether), and diethylenglycoldiethylether.

Examples of suitable polyethers (c) are polyalkylene glycols, preferably poly-C₁-C₄-alkylene glycols and especially polyethylene glycols. Polyethylene glycols may comprise up to 20 mol % of one or more C₁-C₄-alkylene glycols in copolymerized form. Polyalkylene glycols are preferably dimethyl- or diethyl-end capped polyalkylene glycols. The molecular weight M_{w} of suitable polyalkylene glycols and especially of suitable polyethylene glycols may be at least 400 g/mol. The molecular weight M_{w} of suitable polyalkylene glycols and especially of suitable polyethylene glycols may be up to 5 000 000 g/mol, preferably up to 2 000 000 g/mol.

Examples of suitable cyclic ethers (d) are tetrahydrofurane and 1,4-dioxane.

Examples of suitable non-cyclic acetals (e) are 1,1-dimethoxymethane and 1,1-diethoxymethane. Examples for suitable cyclic acetals (e) are 1,3-dioxane and 1,3-dioxolane.

Examples of suitable orthocarboxylic acids esters (f) are tri-C₁-C₄ alkoxy methane, in particular trimethoxymethane and triethoxymethane.

Examples of suitable noncyclic esters of carboxylic acids (g) are ethyl acetate, methyl butanoate, and esters of dicarboxylic acids like 1,3-dimethyl propanedioate. An example of a suitable cyclic ester of carboxylic acids (lactones) is γ-butyrolactone.

Examples of suitable cyclic and noncyclic sulfones (h) are ethyl methyl sulfone and tetrahydrothiophene-1,1-dioxide.

Examples of suitable cyclic and noncyclic nitriles and dinitriles (i) are adiponitrile, acetonitrile, propionitrile, butyronitrile.

### Conducting Salt (ii)

The inventive electrolyte composition (A) furthermore contains at least one conducting salt (ii). Electrolyte composition (A) functions as a medium that transfers ions participating in the electrochemical reaction taking place in an electrochemical cell. The conducting salt(s) (ii) present in the electrolyte are usually solvated in the aprotic organic solvent(s) and comprise one or more suitable lithium salts.

Lithium salts include LiPF₆, LiClO₄, LiN(CF₃SO₂)₂, LiAsF₆, LiCF₃SO₃ and LiBF₄. For example, the electrolyte compositions contain LiPF₆. The lithium salts are generally employed in the organic solvent at a level of from about 0.5 mol/L (M) to about 2.5 M, from about 0.5 M to about 2.0 M, from about 0.7 M to about 1.6 M or from about 0.8 M to about 1.2 M.

Compound of formula (I)

Compound of formula (I) in the electrolyte (A) is defined as:

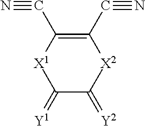

wherein
X¹ and X² are independently from each other selected from N(R¹), P(R¹), O, and S;
R¹ is selected from H, C₁-C₁₀ alkyl, C₃-C₆ (hetero)cycloalkyl, C₂-C₁₀ alkenyl, C₃-C₆ (hetero)cycloalkenyl, C₂-C₆ alkynyl, C₅-C₇ (hetero)aryl, C₇-C₁₃ aralkyl, OR³, C(O)R³, C(NR³)R⁴, and C(O)OR³, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{3a}, OS(O)₂R^{3a}, S(O)₂R^{3a}, OR^{3a}, C(O)R^{3a}, C(O)OR^{3a}, NR^{3a}R^{3b}, and NC(O)R^{3a}R^{3b};
Y¹ and Y² are independently from each other selected from (O), (S), (PR²) and (NR²),
R² is selected from H, C₁-C₁₀ alkyl, C₃-C₆ (hetero)cycloalkyl, C₂-C₁₀ alkenyl, (hetero)C₃-C₆ cycloalkenyl, C₂-C₆ alkynyl, C₅-C₇ (hetero)aryl, C₇-C₁₃ aralkyl, OR^{2a} and C(O)R^{2a}, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{2b}, OS(O)₂R^{2b}, S(O)₂R^{2b}, OR^{2b}, C(O)R^{2b}, C(O)OR^{10b}, NR^{2b}R^{2c}, and NC(O)R^{2b}R^{2c}; and
R^{2a}, R^{2b} and R^{2c} are independently from each other selected from H, C₁-C₁₀ alkyl, C₃-C₆ (hetero)cycloalkyl, C₂-C₁₀ alkenyl, and C₅-C₇ (hetero)aryl, wherein alkyl, (hetero)cycloalkyl, alkenyl, and (hetero)aryl may be substituted by one or more substituents selected from F and CN,
R³, R⁴, R^{3a}, and R^{3b} are selected independently from each other from H, C₁-C₁₀ alkyl, C₃-C₆ (hetero)cycloalkyl, C₂-C₁₀ alkenyl, C₃-C₆ (hetero)cycloalkenyl, C₂-C₆ alkynyl, C₅-C₇ (hetero)aryl, and C₇-C₁₃ aralkyl, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{3c}, OS(O)₂R^{3c}, S(O)₂R^{3c}, OR^{3c}, C(O)R^{3c}, C(O)OR^{3c}, NR^{3c}R^{3d}, and NC(O)R^{3c}CR^{3d};
R^{3c} and R^{3d} are selected independently from each other from H, C₁-C₁₀ alkyl, C₃-C₆ (hetero)cycloalkyl, C₂-C₁₀ alkenyl, and C₅-C₇ (hetero)aryl, wherein alkyl, (hetero)cycloalkyl, alkenyl, and (hetero)aryl may be substituted by one or more substituents selected from F and CN.

The term “C₁-C₁₀ alkyl” as used herein in reference to formula (I) means a straight or branched saturated hydrocarbon group with 1 to 10 carbon atoms having one free valence. Preferred examples of C₁-C₁₀ alkyl are C₁-C₆ alkyl and include, e.g., methyl, ethyl, n-propyl, isopropyl, n-butyl, sec-butyl, isobutyl, tert-butyl, n-pentyl, iso-pentyl, 2,2-dimethylpropyl, n-hexyl, iso-hexyl, 2-ethyl hexyl, n-heptyl, iso-heptyl, n-octyl, iso-octyl, n-nonyl, n-decyl and the like. Preferred are C₁-C₄ alkyl groups and most preferred are 2-propyl, methyl and ethyl. C₁-C₁₀ alkyl may be substituted by one or more groups or atoms selected from CN, F, OR^{3a}, and/or one or more non-adjacent C-atoms of C₁-C₁₀ alkyl may be replaced by oxygen or sulfur. Preferably, in C₁-C₁₀ alkyl no C atoms are replaced by oxygen or sulfur.

The term “C₃-C₆ (hetero)cycloalkyl” as used herein means a cyclic saturated hydrocarbon group with 3 to 6 carbon atoms having one free valence wherein one or more C-atoms may be replaced by N, O or S. Examples of C₃-C₆ cycloalkyl include cyclopropyl, cyclobutyl, cyclopentyl and cyclohexyl, preferred is cyclohexyl. Examples of C₃-C₆ hetero cycloalkyl are oxiranyl and tetrahydrofuryl, preferred is oxiranyl.

The term “C₂-C₁₀ alkenyl” as used herein refers to an unsaturated straight or branched hydrocarbon group with 2 to 10 carbon atoms having one free valence. Unsaturated means that the alkenyl group contains at least one C—C double bond. Preferred examples of C₂-C₁₀ alkenyl are C₂-C₆ alkenyl including for example ethenyl (vinyl), 1-propenyl, 2-propenyl, 1-n-butenyl, 2-n-butenyl, iso-butenyl, 1-pentenyl, 1-hexenyl and the like. Preferred are C₂-C₄ alkenyl groups and in particular ethenyl and propenyl, the preferred propenyl is 1-propen-3-yl, also called allyl.

The term “C₃-C₆ (hetero)cycloalkenyl” as used herein refers to a cyclic unsaturated hydrocarbon group with 3 to 6 carbon atoms having one free valence wherein one or more C-atoms may be replaced by N, O or S. Unsaturated means that the cycloalkenyl contains at least one C—C double bond. Examples of C₃-C₆ (hetero)cycloalkenyl are cyclopropen, cycolbuten, cyclopenten, and cyclohexen.

The term “C₂-C₆ alkynyl” as used herein refers to an unsaturated straight or branched hydrocarbon group with 2 to 6 carbon atoms having one free valence, wherein the hydrocarbon group contains at least one C—C triple bond. C₂-C₁₀ alkynyl includes for example ethynyl, 1-propynyl, 2-propynyl, 1-n-butinyl, 2-n-butynyl, iso-butinyl, 1-pentynyl, 1-hexynyl and the like. Preferred is C₂-C₄ alkynyl, in particular propynyl. The preferred propenyl is 1-propyn-3-yl also called propargyl.

The term “C₅-C₇ (hetero)aryl” as used herein denotes an aromatic 5- to 7-membered hydrocarbon cycle having one free valence, wherein one or more C-atom may be replaced by N, O or S. An example of C₅-C₇ aryl is phenyl, examples of C₅-C₇ heteroaryl are pyrrolyl, furanyl, thiophenyl, pyridinyl, pyranyl, and thiopyranyl.

The term “C₇-C₁₃ aralkyl” as used herein denotes an aromatic 5- to 7-membered hydrocarbon cycle substituted by one or more C₁-C₆ alkyl. The C₇-C₁₃ aralkyl group contains in total 7 to 13 C-atoms and has one free valence. The free valence may be located in the aromatic cycle or in a C₁-C₆ alkyl group, i.e. C₇-C₁₃ aralkyl group may be bound via the aromatic part or via the alkyl part of the group. Examples of C₇-C₁₃ aralkyl are methylphenyl, 1,2-dimethylphenyl, 1,3-dimethylphenyl, 1,4-dimethylphenyl, ethylphenyl, 2-propylphenyl, and the like.

When the term “additive” is applied to formula (I) and (II) the term means the concentration of anyone of the compounds will not exceed about 10 or about 12 wt. % wherein the wt. % is based on the total weight of the electrolyte composition.

For example formula (I) will range from about 0.001 to about 10 wt.-%, for example about 0.01 to about 5 wt.-%, more typically about 0.01 to about 2 or about 3 wt. %, about 0.01 to about 1 wt. % based on the total weight of the electrolyte composition (A).

### Compound of Formula (II)

Compound of formula (II) in electrolyte composition (A) is defined by formula (II)

R⁵—O—R⁶ (II)

wherein R⁵ and R⁶ are independently a partially fluorinated C₁-C₁₀ alkyl group wherein the partially fluorinated C₁-C₁₀ alkyl group is a straight, saturated hydrocarbon chain having some of the hydrogen atoms in the alkyl group substituted by fluorine atoms.

The term “a partially fluorinated C₁₋₁₀ alkyl group in reference to formula (II) means a straight, saturated hydrocarbon group having some of the hydrogen atoms in the alkyl group substituted by fluorine atoms. For example R⁵ and R⁶ may independently range from C₁-C₁₀ alkyl, C₁-C₈ or C₁-C₆ alkyl partially fluorinated. That is R⁵ and R⁶ may independently by partially fluorinated methyl, ethyl, n-propyl, n-butyl, n-pentyl, n-hexyl, n-heptyl n-octyl and the like. More typically the “C₁-C₁₀ alkyl” in reference to formula (II) and substituents R⁵ and R⁶ means a partially fluorinated straight saturated hydrocarbon group of C₁-C₆ alkyl and includes partially fluorinated alkyl, e.g., methyl, ethyl, n-propyl, n-butyl, n-pentyl, n-hexyl. For example methyl, ethyl, n-propyl, n-butyl, n-pentyl and n-hexyl are partially fluorinated and representative of R⁵ and R⁶.

At least one hydrogen atom is present in the partially fluorine substituted R⁵ and R⁶ alkyl groups of formula (II).

R⁵ and R⁶ can be identical or different. R⁵ and R⁶ may have the same number of carbons present in their respective partially fluorinated carbon chains or a different number of carbons present in their respective partially fluorinated carbon chains.

Examples of formula (II) wherein R⁵ and R⁶ are different would be when R⁵ is CF₂CF₂H or —CH₂CF₂H and R⁶ is —CH₂CF₂CF₂CF₂CF₂H or CH₂CF₂CF₂CF₂CF₂H.

The concentration of the additives of formula (II) in the electrolyte composition range from a concentration from 0.001 to 10 or 12 wt. %, for example 0.01 to about 8 wt. %, about 0.01 to about 4 or about 5 wt. % or about 0.01 to about 3 wt. % based on the total weight of the electrolyte composition (A).

The weight ratio of compound of formula (II) to compound of formula (I) in the electrolyte composition will range from about 50:1 to about 1:50. More typically the weight ratio (compound (II)/compound (I)) will range from about 30:1 to about 1:1. For example about 2 wt % of compound of formula (II) and about 0.1 wt. % of compound of formula (I) (where the total wt. of the electrolyte formulation) would give a wt. ratio of about 20 (wt. formula II/wt. formula I).

### Further Additives (iv)

The electrolyte composition (A) may contain at least one further additive (iv) which is selected from the group consisting of vinylene carbonate and its derivatives, vinyl ethylene carbonate and its derivatives, methyl ethylene carbonate and its derivatives, lithium (bisoxalato) borate, lithium difluoro (oxalato) borate, lithium tetrafluoro (oxalato) phosphate, lithium oxalate, 2-vinyl pyridine, 4-vinyl pyridine, cyclic exo-methylene carbonates, sultones, cyclic and acyclic sulfonates, cyclic and acyclic sulfites, cyclic and acyclic sulfinates, organic esters of inorganic acids, acyclic and cyclic alkanes having a boiling point at 1 bar of at least 36° C., and aromatic compounds, optionally halogenated cyclic and acyclic sulfonylimides, optionally halogenated cyclic and acyclic phosphate esters, optionally halogenated cyclic and acyclic phosphines, optionally halogenated cyclic and acyclic phosphites including, optionally halogenated cyclic and acyclic phosphazenes, optionally halogenated cyclic and acyclic silylamines, optionally halogenated cyclic and acyclic halogenated esters, optionally halogenated cyclic and acyclic amides, optionally halogenated cyclic and acyclic anhydrides, dinitriles distinct from the compounds of formula (I), ionic liquids, and optionally halogenated organic heterocycles. The additive (iv) is preferably selected to be different from the compound selected as conducting salt (ii) present in the respective electrolyte composition (A). Preferably additive (iv) is also different from the at least one organic aprotic solvent (i) present in the respective electrolyte composition (A).

Dinitriles distinct from the compounds of formula (I) are for example linear dinitriles such as suberonitrile. The combination of suberonitrile with compounds of formula (I) and compounds of formula (II) give reduced gassing in the electrochemical cell.

Preferred ionic liquids according to the present invention are selected from ionic liquids of formula [K][L] in which:

[K] denotes a cation, preferably reduction-stable, selected from the cation groups of the general formulae (II) to (IX)

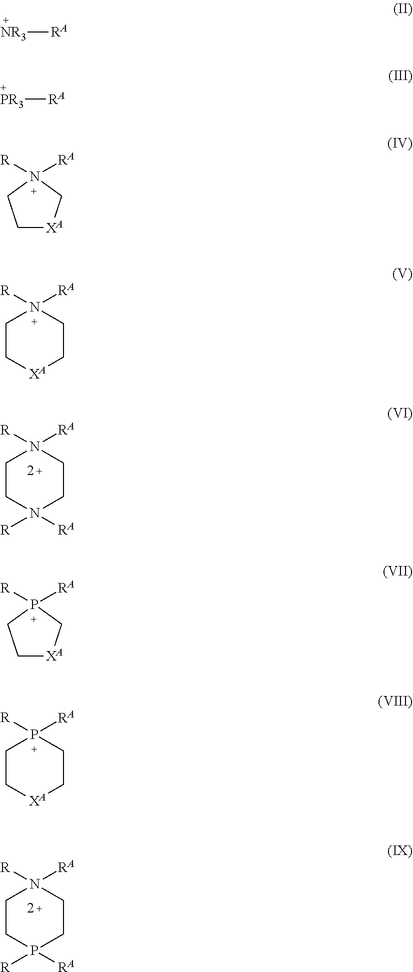

wherein
R denotes H, C₁- to C₆-alkyl, C₂- to C₆-alkenyl, and phenyl, preferably methyl, ethyl, and propyl;
R^{A} denotes —(CH₂)ₛ—O—C(O)—R, —(CH₂)ₛ—C(O)—OR, —(CH₂)ₛ—S(O)₂—OR, —(CH₂)ₛ—O—S(O)₂—R, —(CH₂)ₛ—O—S(O)₂—OR, —(CH₂)ₛ—O—C(O)—OR, —(CH₂)ₛ—HC═CH—R, —(CH₂)ₛ—CN,

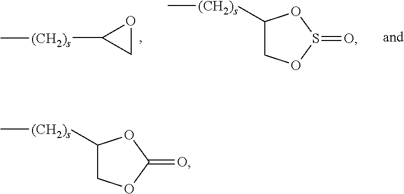

wherein individual CH₂ groups may be replaced by O, S or NR and s=1 to 8, preferably s=1 to 3;
X^{A} denotes CH₂, O, S or NR^{B};
R^{B} denotes H, C₁- to C₆-alkyl, C₂- to C₆-alkenyl, phenyl, and —(CH₂)ₛ—CN with s=1 to 8, preferably s=1 to 3; preferably R^{B} is methyl, ethyl, propyl or H;
   and
   [L] denotes an anion selected from the group BF₄⁻, PF₆⁻, [B(C₂O₄)₂]⁻, [F₂B(C₂O₄)]⁻, [N(S(O)₂F)₂]⁻, [FₚP(C_{q}F_{2q+1})₆₋ₚ]⁻, [N(S(O)₂C_{q}F_{2q+1})₂]⁻, [(C_{q}F_{2q+1})₂P(O)O]⁻, [C_{q}F_{2q+1}P(O)O₂]²⁻, [OC(O)C_{q}F_{2q+1}]⁻, [OS(O)₂C_{q}F_{2q+1}]⁻; [N(C(O)C_{q}F_{2q+1})₂]⁻; [N(C(O)C_{q}F_{2q+1})(S(O)₂C_{q}F_{2q+1})]⁻; [N(C(O)C_{q}F_{2q+1})(C(O))F]⁻; [N(S(O)₂C_{q}F_{2q+1})(S(O)₂F)]⁻; [C(C(O)C_{q}F_{2q+1})₃]⁻, and [C(S(O)₂C_{q}F_{2q+1})₃N(SO₂CF₃)₂]⁻,
   wherein p is an integer in the range from 0 to 6 and q is an integer in the range from 1 to 20, preferably q is an integer in the ranger from 1 to 4.

Preferred ionic liquids for use as additive (iv) are ionic liquids of formula [K][L] in which [K] is selected from pyrrolidinium cations of formula (II) with X is CH₂ and s is an integer in the range of from 1 to 3 and [L] is selected from the group consisting of BF₄⁻, PF₆⁻, [B(C₂O₄)₂]⁻, [F₂B(C₂O₄)]⁻, [N(S(O)₂F)₂]⁻, [N(SO₂C₂F₅)₂²]⁻, [F₃P(C₂F₅)₃]⁻, and [F₃P(C₄F₉)₃]⁻.

If one or more further additives (iv) are present in the electrolyte composition (A), the total concentration of further additives (iv) is at least 0.001 wt.-%, preferred 0.005 to 5 wt.-% and most preferred 0.01 to 2 wt.-%, based on the total weight of the electrolyte composition (A).

A further object of the present invention is the use of at least one compound of formula (I) as defined above as additive for electrolytes in electrochemical cells, preferably in lithium ion secondary electrochemical cells.

Another object of the present invention is an electrochemical cell comprising

(A) the electrolyte composition as described above,
(B) at least one cathode comprising at least one cathode active material, and
(C) at least one anode comprising at least one anode active material.

Preferably the electrochemical cell is a secondary lithium ion electrochemical cell, i.e. secondary lithium ion electrochemical cell comprising a cathode comprising a cathode active material that can reversibly occlude and release lithium ions and an anode comprising a anode active material that can reversibly occlude and release lithium ions. The terms “secondary lithium ion electrochemical cell” and “(secondary) lithium ion battery” are used interchangeably within the present invention.

The cathode active material may include any one or a combination of: NCM (LiₓNiₐMn_{b}CO_{c}O₂, x+a+b+c=2), NCA (LiNiₓCo_{y}Al_{z}O₂, x+y+z=1), LiMn_{1.5}Ni_{0.5}O₂, LiMn₂O₄(LMO) spinel, LiCoO₂ (LCO), or LiMPO₄, wherein M is Fe, Ni, Mn, or Mg. A non-limiting list of example lithium metal oxides may include: mixed metal compositions including lithium, nickel, manganese, and cobalt ions such as lithium nickel cobalt manganese oxide (NCM) (e.g., LiN_{1/3}Co_{1/3}Mn_{1/3}O₂), lithium nickel cobalt aluminum oxide (NCA) (e.g., LiNi_{0.8}Co_{0.15}Al_{0.05}O₂), lithium cobalt oxide (LCO) (e.g., LiCoO₂), lithium metal oxide spinel (LMO-spinel) (e.g., LiMn₂O₄, such as high voltage spinel (HVS)), or LiFePO₄ (e.g. LFP). A variety of cathode active materials may, in combination, be used at the cathode to achieve an appropriate voltage for the lithium ion battery Many elements are ubiquitous. For example, sodium, potassium and chloride are detectable in certain very small proportions in virtually all inorganic materials. In the context of the present invention, proportions of less than 0.5% by weight of cations or anions are disregarded, i.e. amounts of cations or anions below 0.5% by weight are regarded as non-significant. Any lithium ion-containing transition metal oxide comprising less than 0.5% by weight of sodium is thus considered to be sodium-free in the context of the present invention. Correspondingly, any lithium ion-containing mixed transition metal oxide comprising less than 0.5% by weight of sulfate ions is considered to be sulfate-free in the context of the present invention.

The cathode may further comprise electrically conductive materials like electrically conductive carbon and usual components like binders. Compounds suited as electrically conductive materials and binders are known to the person skilled in the art. For example, the cathode may comprise carbon in a conductive polymorph, for example selected from graphite, carbon black, carbon nanotubes, carbon nanofibers, graphene or mixtures of at least two of the aforementioned substances. In addition, the cathode may comprise one or more binders, for example one or more organic polymers like polyethylene, polyacrylonitrile, polybutadiene, polypropylene, polystyrene, polyacrylates, polyvinyl alcohol, polyisoprene and copolymers of at least two comonomers selected from ethylene, propylene, styrene, (meth)acrylonitrile and 1,3-butadiene, especially styrene-butadiene copolymers, and halogenated (co)polymers like polyvinlyidene chloride, polyvinly chloride, polyvinyl fluoride, polyvinylidene fluoride (PVdF), polytetrafluoroethylene, copolymers of tetrafluoroethylene and hexafluoropropylene, copolymers of tetrafluoroethylene and vinylidene fluoride and polyacrylnitrile.

Furthermore, the cathode may comprise a current collector which may be a metal wire, a metal grid, a metal web, a metal sheet, a metal foil or a metal plate. A suited metal foil is aluminum foil.

According to one embodiment of the present invention the cathode has a thickness of from 25 to 200 μm, preferably of from 30 to 100 μm, based on the whole thickness of the cathode without the thickness of the current collector.

The anode (C) comprised within the lithium ion secondary battery of the present invention comprises an anode active material that can reversibly occlude and release lithium ions. In particular carbonaceous material that can reversibly occlude and release lithium ions can be used as anode active material. Carbonaceous materials suited are crystalline carbon such as a graphite material, more particularly, natural graphite, graphitized cokes, graphitized MCMB, and graphitized MPCF; amorphous carbon such as coke, mesocarbon microbeads (MCMB) fired below 1500° C., and mesophase pitch-based carbon fiber (MPCF); hard carbon and carbonic anode active material (thermally decomposed carbon, coke, graphite) such as a carbon composite, combusted organic polymer, and carbon fiber.

Further anode active materials are lithium metal, or materials containing an element capable of forming an alloy with lithium. Non-limiting examples of materials containing an element capable of forming an alloy with lithium include a metal, a semimetal, or an alloy thereof. It should be understood that the term “alloy” as used herein refers to both alloys of two or more metals as well as alloys of one or more metals together with one or more semimetals. If an alloy has metallic properties as a whole, the alloy may contain a nonmetal element. In the texture of the alloy, a solid solution, a eutectic (eutectic mixture), an intermetallic compound or two or more thereof coexist. Examples of such metal or semimetal elements include, without being limited to, titanium (Ti), tin (Sn), lead (Pb), aluminum, indium (In), zinc (Zn), antimony (Sb), bismuth (Bi), gallium (Ga), germanium (Ge), arsenic (As), silver (Ag), hafnium (Hf), zirconium (Zr) yttrium (Y), and silicon (Si). Metal and semimetal elements of Group 4 or 14 in the long-form periodic table of the elements are preferable, and especially preferable are titanium, silicon and tin, in particular silicon. Examples of tin alloys include ones having, as a second constituent element other than tin, one or more elements selected from the group consisting of silicon, magnesium (Mg), nickel, copper, iron, cobalt, manganese, zinc, indium, silver, titanium (Ti), germanium, bismuth, antimony and chromium (Cr). Examples of silicon alloys include ones having, as a second constituent element other than silicon, one or more elements selected from the group consisting of tin, magnesium, nickel, copper, iron, cobalt, manganese, zinc, indium, silver, titanium, germanium, bismuth, antimony and chromium.

A further possible anode active material is silicon which is able to take up lithium ions. The silicon may be used in different forms, e.g. in the form of nanowires, nanotubes, nanoparticles, films, nanoporous silicon or silicon nanotubes. The silicon may be deposited on a current collector. The current collector may be a metal wire, a metal grid, a metal web, a metal sheet, a metal foil or a metal plate. Preferred the current collector is a metal foil, e.g. a copper foil. Thin films of silicon may be deposited on metal foils by any technique known to the person skilled in the art, e.g. by sputtering techniques. One possibility of preparing Si thin film electrodes are described in R. Elazari et al.; Electrochem. Comm. 2012, 14, 21-24. It is also possible to use a silicon/carbon composite as anode active material according to the present invention.

Another possible anode active material are lithium ion intercalating oxides of Ti.

Preferably the anode active material present in the inventive lithium ion secondary battery is selected from carbonaceous material that can reversibly occlude and release lithium ions, particularly preferred the carbonaceous material that can reversibly occlude and release lithium ions is selected from crystalline carbon, hard carbon and amorphous carbon, in particular preferred is graphite. In another preferred embodiment the anode active material present in the inventive lithium ion secondary battery is selected from silicon that can reversibly occlude and release lithium ions, preferably the anode comprises a thin film of silicon or a silicon/carbon composite. In a further preferred embodiment the anode active material present in the inventive lithium ion secondary battery is selected from lithium ion intercalating oxides of Ti.

The anode and cathode may be made by preparing an electrode slurry composition by dispersing the electrode active material, a binder, optionally a conductive material and a thickener, if desired, in a solvent and coating the slurry composition onto a current collector. The current collector may be a metal wire, a metal grid, a metal web, a metal sheet, a metal foil or a metal plate. Preferred the current collector is a metal foil, e.g. a copper foil or aluminum foil.

The inventive lithium ion batteries may contain further constituents customary per se, for example separators, housings, cable connections etc. The housing may be of any shape, for example cuboidal or in the shape of a cylinder, the shape of a prism or the housing used is a metal-plastic composite film processed as a pouch. Suited separators are for example glass fiber separators and polymer-based separators like polyolefin separators.

Several inventive lithium ion batteries may be combined with one another, for example in series connection or in parallel connection. Series connection is preferred. The present invention further provides for the use of inventive lithium ion batteries as described above in devices, especially in mobile devices. Examples of mobile devices are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven staplers. But the inventive lithium ion batteries can also be used for stationary energy stores.

Following are some embodiments of the invention.
E1. An electrolyte composition (A) containing
   (i) at least one aprotic organic solvent;
   (ii) at least one conducting salt;
   (iii) at least one compound of formula (I)

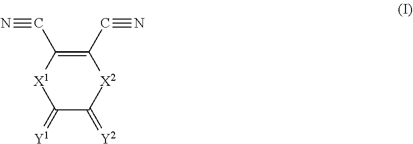

wherein
X¹ and X² are independently from each other selected from N(R¹), P(R¹), O, and S;
R¹ is selected from H, C₁-C₁₀ alkyl, C₃-C₆ (hetero)cycloalkyl, C₂-C₁₀ alkenyl, C₃-C₆ (hetero)cycloalkenyl, C₂-C₆ alkynyl, C₅-C₇ (hetero)aryl, C₇-C₁₃ aralkyl, OR³, C(O)R³, C(NR³)R⁴, and C(O)OR³, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{3a}, OS(O)₂R^{3a}, S(O)₂R^{3a}, OR^{3a}, C(O)R^{3a}, C(O)OR^{3a}, NR^{3a}R^{3b}, and NC(O)R^{3a}R^{3b};
Y¹ and Y² are independently from each other selected from (O), (S), (PR²) and (NR²),
R² is selected from H, C₁-C₁₀ alkyl, C₃-C₆ (hetero)cycloalkyl, C₂-C₁₀ alkenyl, (hetero)C₃-C₆ cycloalkenyl, C₂-C₆ alkynyl, C₅-C₇ (hetero)aryl, C₇-C₁₃ aralkyl, OR^{2a} and C(O)R^{2a}, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{2b}, OS(O)₂R^{2b}, S(O)₂R^{2b}, OR^{2b}, C(O)R^{2b}, C(O)OR^{2b}, NR^{2b}R^{2c}, and NC(O)R^{2b}R^{2c}; and
R^{2a}, R^{2b} and R^{2c} are independently from each other selected from H, C₁-C₁₀ alkyl, C₃-C₆ (hetero)cycloalkyl, C₂-C₁₀ alkenyl, and C₅-C₇ (hetero)aryl, wherein alkyl, (hetero)cycloalkyl, alkenyl, and (hetero)aryl may be substituted by one or more substituents selected from F and CN,
R³, R⁴, R^{3a}, and R^{3b} are selected independently from each other from H, C₁-C₁₀ alkyl, C₃-C₆ (hetero)cycloalkyl, C₂-C₁₀ alkenyl, C₃-C₆ (hetero)cycloalkenyl, C₂-C₆ alkynyl, C₅-C₇ (hetero)aryl, and C₇-C₁₃ aralkyl, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{3c}, OS(O)₂R^{3c}, S(O)₂R^{3c}, OR^{3c}, C(O)R^{3c}, C(O)OR^{3c}, NR^{3c}R^{3d}, and NC(O)R^{3c}R^{3d};
R^{3C} and R^{3d} are selected independently from each other from H, C₁-C₁₀ alkyl, C₃-C₆ (hetero)cycloalkyl, C₂-C₆ alkenyl, and C₅-C₇ (hetero)aryl, wherein alkyl, (hetero)cycloalkyl, alkenyl, and (hetero)aryl may be substituted by one or more substituents selected from F and CN;
and
(iv) at least one compound of formula (II)

R⁵+O+R⁶ (II)
wherein R⁵ and R⁶ are independently a partially fluorinated C₁-C₁₀ alkyl group wherein the partially fluorinated C₁-C₁₀ alkyl group is a straight saturated hydrocarbon chain having some of the hydrogen atoms in the alkyl group substituted by fluorine atoms.
E2. The electrolyte composition (A) according to embodiment 1, wherein the at least one compound of formula (I) is selected from compounds of formula (I) wherein X¹ and X² are independently from each other selected from N(R¹) and O.
E3. The electrolyte composition (A) according to either embodiment 1 or 2, wherein both Y¹ and Y² are the same and each selected from (O) and NR¹.
E4. The electrolyte composition (A) according to any one of embodiments 1 to 3 wherein the at least one compound of formula (I) is compound (I.1)

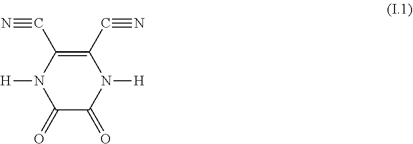 [SMILES: N#Cc1[nH]c(=O)c(=O)[nH]c1C#N]

E5. The electrolyte composition (A) according to any one of embodiments 1 to 4 wherein R⁵ and R⁶ are independently a partially fluorinated C₁-C₈ alkyl group.
E6. The electrolyte composition (A) according to any one of embodiments 1 to 5, wherein R⁵ and R⁶ are identical.
E7. The electrolyte composition (A) according to any one of embodiments 1 to 5, wherein R⁵ and R⁶ are different.
E8. The electrolyte composition (a) according to any one of embodiments 1 to 5 wherein R⁵ and R⁶ have the same number of carbons present in their respective partially fluorinated carbon chains.
E9. The electrolyte composition (A) according to any one of embodiments 1 to 5 or 7, wherein R⁵ and R⁶ have a different number of carbons present in their respective partially fluorinated carbon chains.
E10. The electrolyte composition (A) according to any one of embodiments 1 to 9 claims, wherein R⁵ and R⁶ are independently selected from the group consisting of —CF₂H, —CF₂CF₂H, —CF₂CH₃, —CF₂CF₂CF₂H—, —CF₂CF₂CH₃, —CF₂CF₂CF₂CF₂H —CF₂CF₂CF₂CH₃, —CF₂CF₂CF₂CF₃CH₃, —CF₂CF₂CF₂CF₂CF₂H, —CH₂F, —CH₂CF₃, —CH₂CF₂H, —CH₂CF₂CF₃, —CH₂CF₂CH₃, —CH₂CF₂CF₂H, —CH₂CF₂CF₂CF₃, —CH₂CF₂CF₂CF₂H, —CH₂CF₂CF₂CH₃, —CH₂CF₂CF₂CF₂CF₂H, —CH₂CF₂CF₂CF₂CF₃, —CH₂CF₂CF₂CF₂CH₃, —CH₂CF₂CF₂CF₂CF₂CF₂H, —CH₂CF₂CF₂CF₂CF₂CF₃, —CH₂CF₂CF₂CF₂CF₂CH₃, —CH₂CH₂CF₃, —CH₂CH₂CF₂H, —CH₂CH₂CF₂CF₂H, —CH₂CH₂CF₂CF₃, —CH₂CH₂CF₂CH₃, CH₂CH₂CF₂CF₂CF₂H, —CH₂CH₂CF₂CF₂CF₃, —CH₂CH₂CF₂CF₂CH₃, —CH₂CH₂CF₂CF₂CF₂CF₂H, —CH₂CH₂CF₂CF₂CF₂CF₃ and —CH₂CH₂CF₂CF₂CF₂CH₃.
E11. The electrolyte composition (A) according to embodiment 10, wherein R⁵ and R⁶ are independently selected from the group consisting of —CF₂H, —CF₂CF₂H, —CF₂CF₂CF₂H, —CH₂F, —CH₂CF₂H, —CH₂CF₂CF₂H, —CH₂CF₂CF₂CF₂CF₂H, —CH₂CF₂CF₂CF₂CF₂CF₂H, —CH₂CH₂CF₂H, —CH₂CH₂CF₂CF₂H, —CH₂CH₂CF₂CF₂CF₂H and —CH₂CH₂CF₂CF₂CF₂CF₂H.
E12. The electrolyte composition (A) according to embodiment 11, wherein R⁵ is —CF₂H, —CF₂CF₂H, —CF₂CF₂CF₂H—, —CH₂F, —CH₂CF₂H, —CH₂CH₂CF₂H or —CH₂CF₂CF₂H.
E13. The electrolyte composition (A) according to either embodiment 11 or 12, wherein R⁶ is CH₂CF₂CF₂CF₂CF₂H, —CH₂CF₂CF₂CF₂CF₂CF₂H, —CH₂CH₂CF₂CF₂H, CH₂CH₂CF₂CF₂CF₂H and —CH₂CH₂CF₂CF₂CF₂CF₂H.
E14. The electrolyte composition (A) according to either embodiment 9, wherein R⁵ is CF₂H or —CH₂CF₂H and R⁶ is —CH₂CF₂CF₂CF₂CF₂H or CH₂CF₂CF₂CF₂CF₂H.
E15. The electrolyte composition (A) according to any one of embodiments 1 to 14, wherein the aprotic organic solvent (i) is selected from
   (a) cyclic and noncyclic organic carbonates, which may be partly halogenated,
   (b) di-C₁-C₁₀-alkylethers, which may be partly halogenated,
   (c) di-C₁-C₄-alkyl-C₂-C₆-alkylene ethers and polyethers, which may be partly halogenated,
   (d) cyclic ethers, which may be partly halogenated,
   (e) cyclic and acyclic acetals and ketals, which may be partly halogenated,
   (f) orthocarboxylic acids esters, which may be partly halogenated,
   (g) cyclic and noncyclic esters of carboxylic acids, which may be partly halogenated,
   (h) cyclic and noncyclic sulfones, which may be partly halogenated,
   (i) cyclic and noncyclic nitriles and dinitriles, which may be partly halogenated, and
   (j) ionic liquids, which may be partly halogenated.
E16. The electrolyte composition (A) according to embodiment 15, wherein the electrolyte composition (A) contains at least one aprotic solvent (i) selected from cyclic organic carbonates and at least one aprotic organic solvent (i) selected from noncyclic organic carbonates.
E17. The electrolyte composition (A) according to any one of embodiments 1 to 16, wherein the conducting salt (ii) is selected from the group consisting of LiPF₆, LiClO₄, LiN(CF₃SO₂)₂, LiAsF₆, LiCF₃SO₃ and LiBF₄.
E18. The electrolyte composition (A) according to embodiment 17, wherein the lithium salts are employed in the organic solvent at a level of from about 0.5 mol/L (M) to about 2.5 M, from about 0.5 M to about 2.0 M, from about 0.7 M to about 1.6 M or from about 0.8 M to about 1.2 M.
E19. The electrolyte composition (A) according to any one of embodiments 1 to 18, wherein the electrolyte composition (A) contains at least one further additive (v) which is selected from the group consisting of vinylene carbonate and its derivatives, vinyl ethylene carbonate and its derivatives, methyl ethylene carbonate and its derivatives, lithium (bisoxalato) borate, lithium difluoro (oxalato) borate, lithium tetrafluoro (oxalato) phosphate, lithium oxalate, 2-vinyl pyridine, 4-vinyl pyridine, cyclic exo-methylene carbonates, sultones for example propane sultone, organic esters of inorganic acids, acyclic and cyclic alkanes having a boiling point at 1 bar of at least 36° C., and aromatic compounds, optionally halogenated cyclic and acyclic sulfonylimides, optionally halogenated cyclic and acyclic phosphate esters, optionally halogenated cyclic and acyclic phosphines, optionally halogenated cyclic and acyclic phosphites, optionally halogenated cyclic and acyclic phosphazenes, optionally halogenated cyclic and acyclic silylamines, dinitriles distinct from the compounds of formula (I), optionally halogenated cyclic and acyclichalogenated esters, optionally halogenated cyclic and acyclic amides, optionally halogenated cyclic and acyclic anhydrides, ionic liquids, and optionally halogenated organic heterocycles.
E20. The electrolyte composition (A) according to embodiment 19, wherein the further additive is a dinitrile and the dinitrile is suberonitrile.
E21. The electrolyte composition (A) according to embodiment 20, wherein the concentration of suberonitrile is about 0.001 to about 10 wt. % composition (A), preferably about 0.1 to about 2 wt. % based on the the total weight of the electrolyte.
E22. The electrolyte composition (A) according to any one of the embodiments 1 to 21, wherein the concentration of the at least one compound of formula (I) is about 0.001 to about 10 wt.-%, based on the total weight of the electrolyte composition (A).
E23. The electrolyte composition (A) according to any one of embodiments 1 to 22, wherein the concentration of the at least one compound of formula (II) is about 0.01 to about 10 wt. %, based on the total weight of the electrolyte composition (A).
E24. The electrolyte composition (A) according to any one of embodiments 1 to 23, wherein the weight ratio of the compound of formula (II) to the compound of formula (I) in the electrolyte ranges from about 50 to 1 to about 1 to 50.
E25. The electrolyte composition (A) according to embodiment 23, wherein the weight ratio of the compound of formula (II) to the compound of formula (I) in the electrolyte ranges from about 50 to 1 to about 2 to 1, for example about 40 to 1 to about 10 to 1.
E26. The electrolyte composition (A) according to any one of embodiment 1 to 25, wherein the concentration of the at least one compound of formula (I) ranges from about 0.01 to 2 or 3 wt.-%, based on the total weight of the electrolyte composition (A).
E27. The electrolyte composition (A) according to any one of embodiments 1 to 26, wherein the concentration of the at least one compound of formula (II) ranges from about 0.01 to about 5 wt. % based on the total weight of the electrolyte compositions (A), for example from about 0.1 to about 3 or about 4 wt. %.
E28. The use of the combination of at least one compound of formula (I)

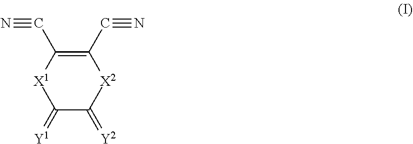

wherein
X¹ and X² are independently from each other selected from N(R¹), P(R¹), O, and S;
R¹ is selected from H, C₁-C₆ alkyl, C₃-C₆ (hetero)cycloalkyl, C₂-C₆ alkenyl, C₃-C₆ (hetero)cycloalkenyl, C₂-C₆ alkynyl, C₅-C₇ (hetero)aryl, C₇-C₁₃ aralkyl, OR³, C(O)R³, C(NR³)R⁴, and C(O)OR³, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{3a}, OS(O)₂R^{3a}, S(O)₂R^{3a}, OR^{3a}, C(O)R^{3a}, C(O)OR^{3a}, NR^{3a}R^{3b}, and NC(O)R^{3a}R^{3b};
Y¹ and Y² are independently from each other selected from (O), (S), (PR²) and (NR²),
R² is selected from H, C₁-C₆ alkyl, C₃-C₆ (hetero)cycloalkyl, C₂-C₆ alkenyl, (hetero)C₃-C₆ cycloalkenyl, C₂-C₆ alkynyl, C₅-C₇ (hetero)aryl, C₇-C₁₃ aralkyl, OR^{2a} and C(O)R^{2a}, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{2b}, OS(O)₂R^{2b}, S(O)₂R^{2b}, OR^{2b}, C(O)R^{2b}, C(O)OR^{10b}, NR^{2b}R^{2c}, and NC(O)R^{2b}R^{2c}; and
R^{2a}, R^{2b} and R^{2c} are independently from each other selected from H, C₁-C₆ alkyl, C₃-C₆ (hetero)cycloalkyl, C₂-C₆ alkenyl, and C₅-C₇ (hetero)aryl, wherein alkyl, (hetero)cycloalkyl, alkenyl, and (hetero)aryl may be substituted by one or more substituents selected from F and CN,
R³, R⁴, R^{3a}, and R^{3b} are selected independently from each other from H, C₁-C₆ alkyl, C₃-C₆ (hetero)cycloalkyl, C₂-C₆ alkenyl, C₃-C₆ (hetero)cycloalkenyl, C₂-C₆ alkynyl, C₅-C₇ (hetero)aryl, and C₇-C₁₃ aralkyl, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{3c}, OS(O)₂R^{3c}, S(O)₂R^{3c}, OR³, C(O)R^{3c}, C(O)OR^{3c}, NR^{3c}R^{3d}, and NC(O)R^{3c}R^{3d};
R^{3c} and R^{3d} are selected independently from each other from H, C₁-C₆ alkyl C₃-C₆ (hetero)cycloalkyl, C₂-C₆ alkenyl, and C₅-C₇ (hetero)aryl, wherein alkyl, (hetero)cycloalkyl, alkenyl, and (hetero)aryl may be substituted by one or more substituents selected from F and CN;
and at least one compound of formula (II)

R⁵—O—R⁶ (II)

wherein R⁵ and R⁶ are independently a partially fluorinated C₁-C₁₀ alkyl group wherein the partially fluorinated C₁-C₁₀ alkyl means a straight saturated hydrocarbon group having some of the hydrogen atoms in the alkyl group substituted by fluorine atoms as additives for electrolytes in electrochemical cells.
E29. An electrochemical cell comprising
   (A) the electrolyte composition (A) according to any one of embodiments 1 to 27,
   (B) at least one cathode comprising at least one cathode active material, and
   (C) at least one anode comprising at least one anode active material.
E30. The electrochemical cell according to embodiment 29, wherein the electrochemical cell is a secondary lithium ion battery.
E31. The electrochemical cell according to either embodiment 29 or 30 wherein at least one cathode active material comprises a material capable of occluding and releasing lithium ions selected from lithiated transition metal phosphates and lithium ion intercalating transition metal oxides.
E32. The electrochemical cell according to any one of embodiment 29, 30 or 31, wherein the cathode active material is a lithium transition metal oxide material.
E33. The electrochemical cell according to embodiment 32, wherein the cathode active material is one or a combination of: NCM (LiₓNiₐMn_{b}Co_{c}O₂, x+a+b+c=2), NCA (LiNiₓCo_{y}Al_{z}O₂, x+y+z=1), LiMn_{1.5}Ni_{0.5}O₂, LiMn₂O₄(LMO) spinel, LiCoO₂ (LCO), or LiMPO₄, wherein M is Fe, Ni, Mn, or Mg.
E34. The electrochemical cell according to embodiment 33, wherein the cathode active material is LiN_{1/3}Co_{1/3}Mn_{1/3}O₂, LiNi_{0.8}Co_{0.15}Al_{0.05}O₂, LiCoO₂), LiMn₂O₄, such as high voltage spinel (HVS)), or LiFePO₄.
E35. The electrochemical cell according to embodiment 33, wherein the cathode active material is LiMn₂O₄(LMO) spinel or LiCoO₂ (LCO).
E36. The electrochemical cell according to any one of embodiments 28 to 35, wherein the at least one anode active material comprises a lithium ion intercalating material selected from lithium ion intercalating carbonaceous material, lithium ion intercalating oxides of Ti, and lithium ion uptaking silicon.

The invention is illustrated by the examples which follow, which do not, however, restrict the invention.

### EXPERIMENTS

### Example 1

Pouch type cells were used to prepare the electrochemical cell. A high voltage LCO (LiCoO₂) was used as cathode active material. The anode was a graphite anode.

The base electrolyte composition (Base EL) contained 1.2 M LiPF6 in a mixed cyclic and acyclic carbonate solvent of ethylene carbonate (EC):propylene carbonate (PC), ethylmethyl carbonate (EMC), diethyl carbonate (DEC), Fluoroethylene carbonate (FEC) in a weight ratio of 90%-99% based on the total weight of the lithium non-aqueous electrolyte, mixed additives of sultone, substituted Ethylene Carbonate, and linear dinitriles, in an amount of 1%-15% based on the total Weight of the lithium non-aqueous electrolyte, to prepare an electrolyte for a secondary battery. The amount of electrolyte composition used per cell was 6 g.

Electrochemical test: The electrochemical test was done in LANQI battery testing system (BK-6816AR/20) at 45° C., Battery cycling test were performed at 45° C., with 0.7 C-rate charge and 1 C-rate discharge in a voltage range of 4.45V˜3.0V illustrating the capacity retention after 500 cycles of lithium batteries with and without additives in the electrolyte solution at elevated temperature in accordance with one embodiment of the invention

Storage test: present the thickness swelling ratio for the fully charged batteries containing the electrolyte solution after storing at 60° C. for 21 days.
Compound A—1H,1H,5H-Perfluoropentyl-1,1,2,2-tetrafluoroethylether (CAS Reg. #16627-71-7)
Compound B—1,4,5,6-tetrahydro-5,6-dioxo-2,3-pyrazinedicarbonitrile (CAS Reg. #36023-64-0)
Compound C—Adiponitril (111-69-3)
Compound D—Suberonitrile (629-40-3)
   Test results:

TABLE 1

| | | Test Result | |
|---|---|---|---|
| | | | HT 60° C.@21 |
| | | | d storage |
| | | HT 45° C. | Test condition: |
| | | 500 cycles | 0.5 C full charged |
| | | Test condition: | to 4.45 V, after 60° |
| | | 0.7 C/1.0 C | C.@21 d storage, test |
| Code | Formula | 3.0 V~4.45 V | thickness welling ratio |
| Comparative | Base EL | 64.7% | 2.7% |
| example 1# | | | |
| Comparative | Base EL + 2% | 64.0% | 3.0% |
| example 2# | Compound A | | |
| Comparative | Base EL + 0.1% | 67.4% | 1.8% |
| example 3# | Compound B | | |
| Inventive | Base EL + 0.1% | 73.1% | 1.8% |
| example 4# | Compound B + | | |
| | 2% A | | |

TABLE 2

| | | Test Result | |
|---|---|---|---|
| | | | HT 60° |
| | | | C.@21 d storage |
| | | HT 45° | Test condition: |
| | | C.@500 cycles | 0.5 C full charged |
| | | Test condition: | to 4.45 V, after 60° |
| | | 0.7 C/1.0 C | C.@21 d storage, test |
| Code | Formula | 3.0 V~4.45 V | thickness swelling ratio |
| Comparative | Base EL + 2% | 64.70% | 2.7% |
| example 4# | Compound C | | |
| Comparative | Base EL + 2% | 62.7% | 1.9% |
| example 5# | Compound D | | |
| Inventive | Base EL + 2% | 68.0% | 1.8% |
| example 5# | Compound A + | | |
| | 0.1% Com- | | |
| | pound B | | |
| Inventive | Base EL + | 71.1% | 1.0% |
| example 6# | Compound 2% | | |
| | A + 0.1% | | |
| | B + 2% D | | |

Note in Table 2 the combination of the additional linear dinitriles, suberonitrile (compound D) to the Base EL with compounds A + B, the gassing of the electrochemical cell can be further reduced (1.8% vs. 1.0% for inventive example 6#).

All tests were carried out using the same EL base and anode and cathode.

1: An electrolyte composition (A), comprising:
(i) at least one aprotic organic solvent;
(ii) at least one conducting salt;
(iii) at least one compound of formula (I): 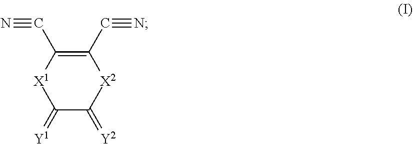
and
(iv) at least one compound of formula (II):
R⁵—O—R⁶ (II),
wherein:
X¹ and X² are independently from each other selected from N(R¹), P(R¹), O, and S;
R¹ is selected from H, C₁-C₁₀ alkyl, C₃-C₆ (hetero)cycloalkyl, C₂-C₁₀ alkenyl, C₃-C₆ (hetero)cycloalkenyl, C₂-C₆ alkynyl, C₅-C₇ (hetero)aryl, C₇-C₁₃ aralkyl, OR³, C(O)R³, C(NR³)R⁴, and C(O)OR³, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{3a}, OS(O)₂R^{3a}, S(O)₂R^{3a}, OR^{3a}, C(O)R^{3a}, C(O)OR^{3a}, NR^{3a}R^{3b}, and NC(O)R^{3a}R^{3b};
Y¹ and Y² are independently from each other selected from (O), (S), (PR²) and (NR²),
R² is selected from H, C₁-C₁₀ alkyl, C₃-C₆ (hetero)cycloalkyl, C₂-C₁₀ alkenyl, (hetero)C₃-C₆ cycloalkenyl, C₂-C₆ alkynyl, C₅-C₇ (hetero)aryl, C₇-C₁₃ aralkyl, OR^{2a} and C(O)R^{2a}, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{2b}, OS(O)₂R^{2b}, S(O)₂R^{2b}, OR^{2b}, C(O)R^{2b}, C(O)OR^{2b}, NR^{2b}R^{2c}, and NC(O)R^{2b}R^{2c};
R^{2a}, R^{2b} and R^{2c} are independently from each other selected from H, C₁-C₁₀ alkyl, C₃-C₆ (hetero)cycloalkyl, C₂-C₁₀ alkenyl, and C₅-C₇ (hetero)aryl, wherein alkyl, (hetero)cycloalkyl, alkenyl, and (hetero)aryl may be substituted by one or more substituents selected from F and CN,
R³, R⁴, R^{3a}, and R^{3b} are selected independently from each other from H, C₁-C₁₀ alkyl, C₃-C₆ (hetero)cycloalkyl, C₂-C₁₀ alkenyl, C₃-C₆ (hetero)cycloalkenyl, C₂-C₆ alkynyl, C₅-C₇ (hetero)aryl, and C₇-C₁₃ aralkyl, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{3c}, OS(O)₂R^{3c}, S(O)₂R^{3c}, OR^{3c}, C(O)R^{3c}, C(O)OR^{3c}, NR^{3c}R^{3d}, and NC(O)R^{3c}R^{3d};
R^{3c} and R^{3d} are selected independently from each other from H, C₁-C₁₀ alkyl, C₃-C₆ (hetero)cycloalkyl, C₂-C₆ alkenyl, and C₅-C₇ (hetero)aryl, wherein alkyl, (hetero)cycloalkyl, alkenyl, and (hetero)aryl may be substituted by one or more substituents selected from F and CN; and
R⁵ and R⁶ are independently a partially fluorinated C₁-C₁₀ alkyl group wherein the partially fluorinated C₁-C₁₀ alkyl group is a straight saturated hydrocarbon chain having some of the hydrogen atoms in the alkyl group substituted by fluorine atoms.

2: The electrolyte composition (A) according to claim 1, wherein the at least one compound of formula (I) is compound (I.1):

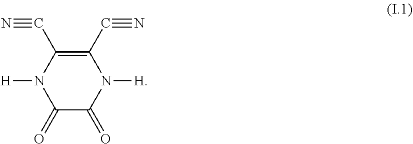

3: The electrolyte composition (A) according to claim 1, wherein R⁵ and R⁶ are independently a partially fluorinated C₁-C₈ alkyl group.

4: The electrolyte composition (A) according to claim 1, wherein R⁵ and R⁶ are independently selected from the group consisting of —CF₂H, —CF₂CF₂H, —CF2CH3, —CF₂CF₂CF₂H—, —CF₂CF₂CH₃, —CF₂CF₂CF₂CF₂H —CF₂CF₂CF₂CH₃, —CF2CF2CF2CF3CH3, —CF₂CF₂CF₂CF₂CF₂H, —CH₂F, —CH₂CF₃, —CH₂CF₂H, —CH₂CF₂CF₃, —CH₂CF₂CH₃, —CH₂CF₂CF₂H, —CH₂CF₂CF₂CF₃, —CH₂CF₂CF₂CF₂H, —CH₂CF₂CF₂CH₃, CH₂CF₂CF₂CF₂CF₂H, —CH₂CF₂CF₂CF₂CF₃, —CH₂CF₂CF₂CF₂CH₃, —CH₂CF₂CF₂CF₂CF₂CF₂H, —CH₂CF₂CF₂CF₂CF₂CF₃, —CH₂CF₂CF₂CF₂CF₂CH₃, —CH₂CH₂CF₃, —CH₂CH₂CF₂H, —CH₂CH₂CF₂CF₂H, —CH₂CH₂CF₂CF₃, —CH₂CH₂CF₂CH₃, CH₂CH₂CF₂CF₂CF₂H, —CH₂CH₂CF₂CF₂CF₃, —CH₂CH₂CF₂CF₂CH₃, —CH₂CH₂CF₂CF₂CF₂CF₂H, —CH₂CH₂CF₂CF₂CF₂CF₃ and —CH₂CH₂CF₂CF₂CF₂CH₃.

5: The electrolyte composition (A) according to claim 1, wherein the aprotic organic solvent (i) is selected from the group consisting of
(a) cyclic and noncyclic organic carbonates, which may be partly halogenated,
(b) di-C₁-C₁₀-alkylethers, which may be partly halogenated,
(c) di-C₁-C₄-alkyl-C₂-C₆-alkylene ethers and polyethers, which may be partly halogenated,
(d) cyclic ethers, which may be partly halogenated,
(e) cyclic and acyclic acetals and ketals, which may be partly halogenated,
(f) orthocarboxylic acids esters, which may be partly halogenated,
(g) cyclic and noncyclic esters of carboxylic acids, which may be partly halogenated,
(h) cyclic and noncyclic sulfones, which may be partly halogenated,
(i) cyclic and noncyclic nitriles and dinitriles, which may be partly halogenated, and
(j) ionic liquids, which may be partly halogenated.

6: The electrolyte composition (A) according to claim 1, wherein the conducting salt (ii) is selected from the group consisting of LiPF₆, LiClO₄, LiN(CF₃SO₂)₂, LiAsF₆, LiCF₃SO₃ and LiBF₄.

7: The electrolyte composition (A) according to claim 1, further comprising:
(v) at least one further additive (v) which is selected from the group consisting of vinylene carbonate and its derivatives, vinyl ethylene carbonate and its derivatives, methyl ethylene carbonate and its derivatives, lithium (bisoxalato) borate, lithium difluoro (oxalato) borate, lithium tetrafluoro (oxalato) phosphate, lithium oxalate, 2-vinyl pyridine, 4-vinyl pyridine, cyclic exo-methylene carbonates, sultones for example propane sultone, organic esters of inorganic acids, acyclic and cyclic alkanes having a boiling point at 1 bar of at least 36° C., and aromatic compounds, optionally halogenated cyclic and acyclic sulfonylimides, optionally halogenated cyclic and acyclic phosphate esters, optionally halogenated cyclic and acyclic phosphines, optionally halogenated cyclic and acyclic phosphites, optionally halogenated cyclic and acyclic phosphazenes, optionally halogenated cyclic and acyclic silylamines, optionally halogenated cyclic and acyclic halogenated esters, optionally halogenated cyclic and acyclic amides, optionally halogenated cyclic and acyclic anhydrides, dinitriles distinct from the compounds of formula (I), ionic liquids, and optionally halogenated organic heterocycles.

8: The electrolyte composition (A) according to claim 7, wherein the further additive is a dinitrile and the dinitrile is suberonitrile.

9: The electrolyte composition (A) according to claim 1, wherein the concentration of the at least one compound of formula (I) is 0.001 to 10 wt %, based on the total weight of the electrolyte composition (A).

10: The electrolyte composition (A) according to claim 1, wherein the concentration of the at least one compound of formula (II) is 0.01 to about 10 wt. %, based on the total weight of the electrolyte composition (A).

11: An additive for electrolytes in electrochemical cells, the additive comprising:
at least one compound of formula (I): 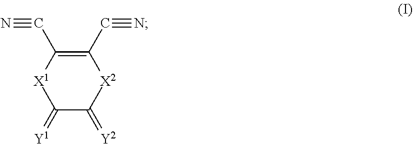
and
at least one compound of formula (II):
R⁵—O—R⁶ (II),
wherein:
X¹ and X² are independently from each other selected from N(R¹), P(R¹), O, and S;
R¹ is selected from H, C₁-C₆ alkyl, C₃-C₆ (hetero)cycloalkyl, C₂-C₆ alkenyl, C₃-C₆ (hetero)cycloalkenyl, C₂-C₆ alkynyl, C₅-C₇ (hetero)aryl, C₇-C₁₃ aralkyl, OR³, C(O)R³, C(NR³)R⁴, and C(O)OR³, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{3a}, OS(O)₂R^{3a}, S(O)₂R^{3a}, OR^{3a}, C(O)R^{3a}, C(O)OR^{3a}, NR^{3a}R^{3b}, and NC(O)R^{3a}R^{3b};
Y¹ and Y² are independently from each other selected from (O), (S), (PR²) and (NR²);
R² is selected from H, C₁-C₆ alkyl, C₃-C₆ (hetero)cycloalkyl, C₂-C₆ alkenyl, (hetero)C₃-C₆ cycloalkenyl, C₂-C₆ alkynyl, C₅-C₇ (hetero)aryl, C₇-C₁₃ aralkyl, OR^{2a} and C(O)R^{2a}, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{2b}, OS(O)₂R^{2b}, S(O)₂R^{2b}, OR^{2b}, C(O)R^{2b}, C(O)OR^{10b}, NR^{2b}R^{2c}, and NC(O)R^{2b}R^{2c}; and
R^{2a}, R^{2b} and R^{2c} are independently from each other selected from H, C₁-C₆ alkyl, C₃-C₆ (hetero)cycloalkyl, C₂-C₆ alkenyl, and C₅-C₇ (hetero)aryl, wherein alkyl, (hetero)cycloalkyl, alkenyl, and (hetero)aryl may be substituted by one or more substituents selected from F and CN;
R³, R⁴, R^{3a}, and R^{3b} are selected independently from each other from H, C₁-C₆ alkyl, C₃-C₆ (hetero)cycloalkyl, C₂-C₆ alkenyl, C₃-C₆ (hetero)cycloalkenyl, C₂-C₆ alkynyl, C₅-C₇ (hetero)aryl, and C₇-C₁₃ aralkyl, wherein alkyl, (hetero)cycloalkyl, alkenyl, (hetero)cycloalkenyl, alkynyl, (hetero)aryl, and aralkyl may be substituted by one or more substituents selected from F, CN, C₁-C₆ alkyl, C₃-C₆ (hetero)cycloalkyl, C₂-C₆ alkenyl, C₅-C₇ (hetero)aryl, S(O)₂OR^{3c}, OS(O)₂R^{3c}, S(O)₂R^{3c}, OR^{3c}, C(O)R^{3c}, C(O)OR^{3c}, NR^{3c}R^{3d}, and NC(O)R^{3c}R^{3d};
R^{3c} and R^{3d} are selected independently from each other from H, C₁-C₆ alkyl C₃-C₆ (hetero)cycloalkyl, C₂-C₆ alkenyl, and C₅-C₇ (hetero)aryl, wherein alkyl, (hetero)cycloalkyl, alkenyl, and (hetero)aryl may be substituted by one or more substituents selected from F and CN; and
R⁵ and R⁶ are independently a partially fluorinated C₁-C₁₀ alkyl group wherein the partially fluorinated C₁-C₁₀ alkyl means a straight saturated hydrocarbon group having some of the hydrogen atoms in the alkyl group substituted by fluorine atoms.

12: An electrochemical cell, comprising:
(A) the electrolyte composition (A) according to claim 1;
(B) at least one cathode comprising at least one cathode active material; and
(C) at least one anode comprising at least one anode active material.

13: The electrochemical cell according to claim 12, wherein the electrochemical cell is a secondary lithium ion battery.

14: The electrochemical cell according to claim 12, wherein at least one cathode active material comprises a material capable of occluding and releasing lithium ions selected from lithiated transition metal phosphates and lithium ion intercalating transition metal oxides.

15: The electrochemical cell according to claim 12, wherein the at least one anode active material comprises a lithium ion intercalating material selected from lithium ion intercalating carbonaceous material, lithium ion intercalating oxides of Ti, and lithium ion uptaking silicon.
